(19) United States
(12) Patent Application Publication
(10) Pub. No.: US 2004/0121060 A1
(43) Pub. Date: Jun. 24, 2004

(54) Narrow wavy noodle and extrusion die for manufacturing the same

(76) Inventor: Neung Ku Lee, Koyang-City (KR)

Correspondence Address: Felix J. D' Ambrosio, JONES, TULLAR & COOPER, P.C., P.O. Box 2266 Eads Station, Arlington, VA, 22202, US

(21) Appl. No.: 10/435,472

(22) Filed: May 12, 2003

(30) Foreign Application Priority Data
Dec. 20, 2002 (KR) 10-2002-0081720

(51) Int. Cl. A23L 1/00

(52) U.S. Cl. 426/557

(57) ABSTRACT

Disclosed herein is narrow wavy noodle, and an extrusion die for manufacturing the narrow wavy noodle. In the prior art, the wavy noodle is formed by applying a certain physical force to noodle strings having a constant thickness, which are extruded into an elongate shape through extrusion holes of an extruder, so as to repeatedly push and pull them in all directions, thereby bending them. Or alternately, the wavy noodle is formed by alternately adjusting the relative rotation speeds of the opposing rollers for cutting a flat dough sheet into elongate noodle strings. However, the conventional wavy noodle has a problem in that the wavy noodle has a relatively long wavelength. Namely, the bending of the noodle has little effect on the quality thereof. Therefore, the present invention provides narrow wavy noodle having a corrugated contour of a considerably small wavelength wherein peaks and valleys are formed to substantially come in contact with one another, thereby increasing the whole surface area of the noodle, and being easily softened in water. In addition, the resulting wavy noodle appears thick in spite of its actual thin configuration, and exhibits a soft texture during chewing. The present invention also provides an extrusion die for manufacturing the narrow wavy noodle.

### BACKGROUND OF THE INVENTION

1. Field of the Invention

The present invention relates to narrow wavy noodle, which is shaped to have a corrugated contour by bending thereof. The present invention also relates to an extrusion die for manufacturing this kind of narrow wavy noodle. The term “noodle” will be used throughout in a sense to include general thin noodles and cold noodles.

2. Description of the Related Art

In the prior art, the formation of narrow wavy noodle having a corrugated contour has been performed using two representative methods. In one of the methods, the narrow wavy noodle is formed by applying a certain physical force to noodle strings having a constant thickness, which are extruded into an elongate shape through extrusion holes of an extruder, so as to repeatedly push and pull them in all directions, thereby bending them. In the other method using a pair of opposite rollers for cutting a flat dough sheet into elongate noodle strings, the narrow wavy noodle is formed by alternately adjusting the relative rotation speeds of the opposing rollers.

The narrow wavy noodle manufactured by the above conventional methods, however, has several problems. For example, the narrow wavy noodle has a corrugated contour of a relatively long wavelength. Namely, a bending process has little effect on the quality of the noodle. Thus, the noodle strings cannot be easily softened in water, and fail to exhibit a favorable chewiness. In the case of the prior art narrow wavy noodle, the softening of the noodle strings in water and the texture thereof depend only on the thickness of the noodle strings.

### SUMMARY OF THE INVENTION

Therefore, the present invention has been made in view of the above problems, and it is an object of the present invention to provide narrow wavy noodle, each string of the noodle being shaped by bending to have a corrugated contour wherein its wavelength is short and peaks or valleys formed thereon have a short height or depth, the respective peaks or valleys of each string being connected with each other through a connector. As each noodle string is bent into a corrugated contour and adapted to continuously maintain the corrugated contour, the whole surface area of the noodle is increased, thereby allowing the noodle to be easily softened in water and improving its texture.

It is another object of the present invention to provide an extrusion die for manufacturing the narrow wavy noodle as stated above.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a perspective view illustrating a narrow wavy noodle according to the present invention;

FIG. 1b is a perspective view illustrating a narrow wavy noodle of the prior art;

FIG. 2a is a schematic view illustrating an extrusion die for manufacturing the narrow wavy noodle of the present invention;

FIG. 2b is an enlarged view illustrating one of plural extrusion holes formed at the extrusion die; and

FIG. 3 is a perspective view illustrating the extruded narrow wavy noodle string of the present invention having just passed through one extrusion hole.

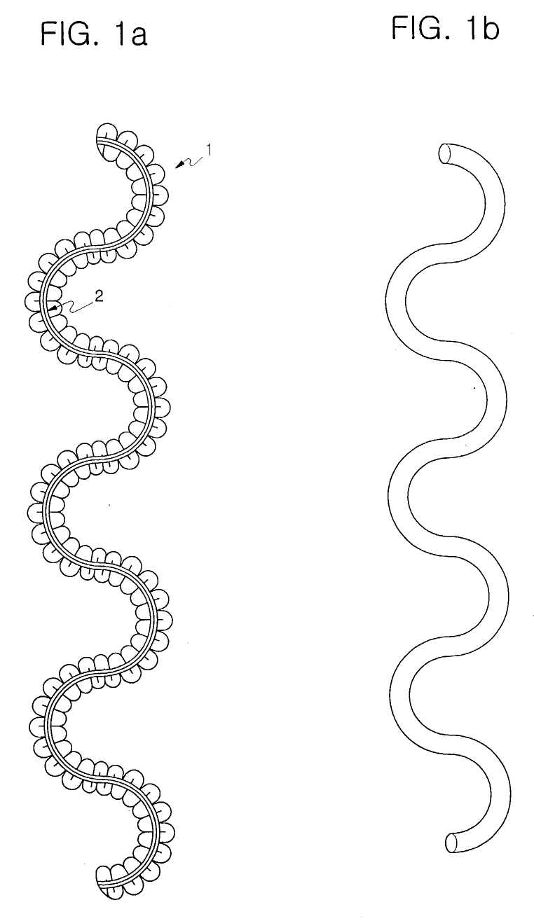

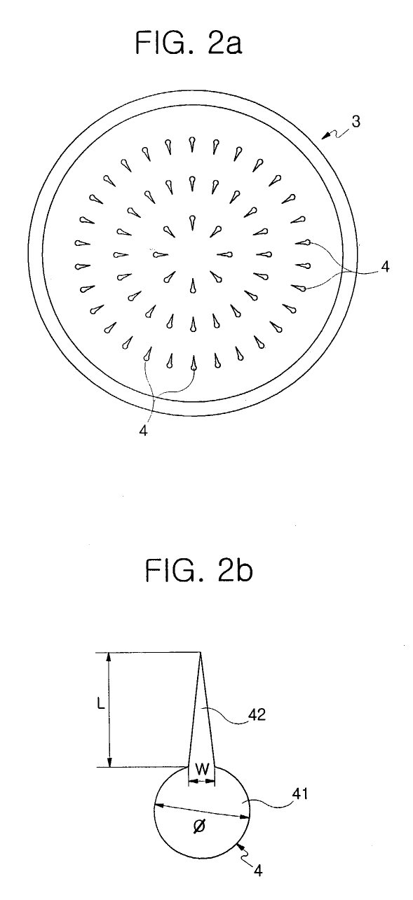

### DESCRIPTION OF THE PREFERRED EMBODIMENTS

The present invention is characterized by an extrusion die 3 for manufacturing narrow wavy noodle, the extrusion die 3 being formed with a plurality of extrusion holes 4, each extrusion hole 4 having a main extrusion hole 41 and a connector extrusion hole 42.

Preferably, the main extrusion hole 41 has a diameter of 0.6 mm to 1.0 mm. The connector extrusion hole 42, formed to be continuous with the main extrusion hole 41, has a pointed shape narrowing toward its tip. Preferably, the connector extrusion hole 42 has a length L of 1 mm to 3 mm, and a width W of 0.1 mm to 0.3 mm at its base connected to the main extrusion hole 41.

For the extrusion of the narrow wavy noodle strings or strands, the extrusion die 3 of the present invention constructed as stated above is mounted in a conventional noodle extruding machine (not shown), and then an extrusion screw is rotated at 1500 to 2000 RPM to extrude a starting wheat dough. The wheat dough has a moisture content of 40 to 60%, preferably. It would be understood that any other grain ingredients may be admixed and kneaded to form the dough.

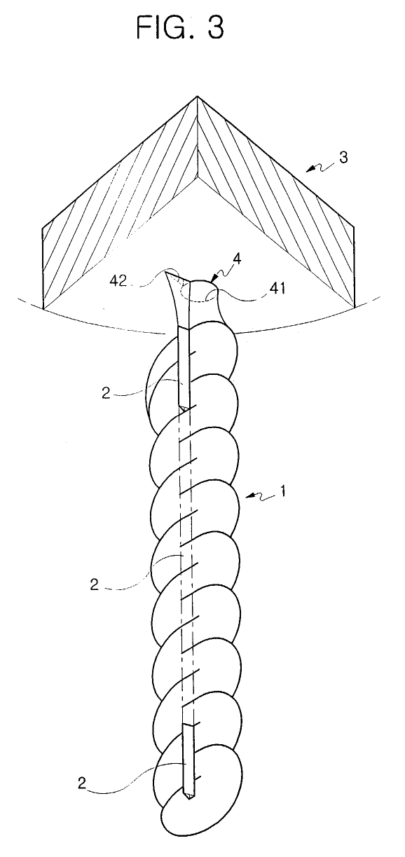

The prepared dough is extruded through the main extrusion hole 41 and connector extrusion hole 42 while being heated by frictional heat produced between the dough and extrusion screw. Through the main extrusion hole 41 and connector extrusion hole 42 constituting each extrusion hole 4, a noodle string 1 connected with a connector 2 is extruded. An extrusion speed of the connector 2 is considerably slower than that of the noodle string 1. Specifically, the extrusion speed of the connector 2 at the tip of the connector extrusion hole 42 is slower than the extrusion speed of the base of the connector extrusion hole 42 connected to the main extrusion hole 41. As a result, the connector 2, having been extruded slowly through the connector extrusion hole 42, is adapted to apply pulling tension to the noodle string 1, having extruded quickly through the main extrusion hole 41. In this way, as shown in FIG. 3, the noodle string 1 is alternately bent in left and right directions about the connector 2. By virtue of the heating of the wheat dough and the high-speed rotation of the extrusion screw, the viscosity of the dough is increased, thus the connector 2 can sufficiently and stably apply pulling tension to the noodle string 1.

As apparent from the above description, the present invention provides a wavy narrow noodle which is configured to be appear thick in spite of its actual thin configuration, thereby producing a delicious appearance and soft texture, and being easily softened in water and having a favorable chewiness.

Further, according to the present invention, the manufacturing method of the narrow wavy noodle does not need a separate drying step after extrusion. Namely, the manufactured narrow wavy noodle is cooled naturally at a normal temperature only to eliminate a hot air, and then packed. As a result, the noodle can be instantly cooked by simply pouring hot water onto and over the noodle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. Narrow wavy noodle comprising:
noodle strings connected with connectors, each noodle string being alternately bent in left and right directions about each connector to define a corrugated contour.

2. An extrusion die for manufacturing narrow wavy noodle comprising:
a plurality of extrusion holes, each hole having a main extrusion hole and a connector extrusion hole continuous with the main extrusion hole and connected to the circumference of the main extrusion hole.

3. The extrusion die as set forth in claim 2, wherein:
the main extrusion hole has a diameter of 0.6 mm to 1.0 mm; and
the connector extrusion hole, formed into a pointed shape narrowing toward its tip, has a length of 1 mm to 3 mm, and a width of 0.1 mm to 0.3 mm at a base connected to the main extrusion hole.
